(19) United States
(12) Patent Application Publication
(10) Pub. No.: US 2014/0150393 A1
(43) Pub. Date: Jun. 5, 2014

(54) Knife carrier for a chopper drum and chopper drum for a forage harvester

(71) Applicant: CLAAS SAULGAU GMBH, BAD SAULGAU (DE)

(72) Inventor: Martin Stengele, Sauldorf (DE)

(73) Assignee: CLAAS SAULGAU GMBH, BAD SAULGAU (DE)

(21) Appl. No.: 14/035,343

(22) Filed: Sep. 24, 2013

(30) Foreign Application Priority Data
Nov. 30, 2012 (DE) 10 2012 023 431.7

(51) Int. Cl. A01D 43/08

(52) U.S. Cl. CPC A01D 43/088
USPC 56/60

(57) ABSTRACT

A knife carrier for a chopper drum is formed with a plurality of knife carrier segments, each designed as a circular-ring disk section of a circular-ring disk that can be accommodated on an outer diameter of a circular-cylindrical drum body of the chopper drum. The knife carrier segments each have an outer-peripheral surface having a predetermined number of knife receptacles. The knife carrier segments each have a circumferential length such that all the knife carrier segments form the circular-ring disk when placed next to one another along the circumferential length thereof. Each knife carrier segment has fixing means for the defined positioning of the knife carrier segments with respect to the drum body and for the detachable attachment of the knife carrier segment on the outer diameter of the drum body.

### CROSS-REFERENCE TO A RELATED APPLICATION

The invention described and claimed hereinbelow is also described in German Priority Document DE 10 2012 023431.7, filed on Nov. 30, 2012. The German Priority Document, the subject matter of which is incorporated herein by reference, provides the basis for a claim of priority of invention under 35 U.S.C. 119(a)-(d).

### BACKGROUND OF THE INVENTION

The invention relates to a knife carrier for a chopper drum of a forage harvester, and to a chopper drum for a forage harvester.

Agricultural forage harvesters comprise a chopper unit equipped with a cutting cylinder. Cutting blades, which are attached on the circumference of the cutting cylinder and therefore rotate, interact with a stationary shear bar. Crop (such as corn plants) that is conveyed into an engagement region formed by the rotating cutting cylinder and the shear bar is cut and chopped via the interaction of the cutting blades (which are attached to the rotating cutting cylinder) with the shear bar. The cutting cylinder is therefore also commonly referred to as a chopper drum.

A conventional chopper drum for a forage harvester comprises a circular-cylindrical drum body having a predetermined outer diameter and a plurality of knife carriers. Each of the knife carriers has a plurality of knife receptacles, each of which is positioned in a defined manner relative to the drum body and is detachably attached at the outer diameter thereof.

A drum jacket defining the outer diameter of the drum body has two axial ends pointing in opposite directions. A first pair of knife carriers, which are each designed as a circular-ring disk, are positioned on the drum body approximately in the axial center thereof, at a predetermined axial distance from one another, and are each detachably attached there by means of threaded connections. A second pair of knife carriers, which are each designed as circular disks, are mounted on the sides at the axial ends of the drum body and are each detachably attached there by means of threaded connections. A journal is detachably attached by means of threaded connections to each of the two outer, circular-disk shaped knife carriers via a flange provided on each of the journals. Such construction ensures that a rotatable support and a rotary drive of the chopper drum can be obtained by means of the journals.

Chopper drums also are known in which the knife carriers are non-detachably attached to the drum jacket surface. Such knife carriers are usually attached to the drum jacket surface by means of welded joints and each comprise receptacles for a knife.

A commonly known chopper drum of the type described above has a few disadvantages, however, in terms of the amount of effort required for production, maintenance, and repair.

For example, if one or more of the knife carriers becomes damaged (e.g. deformation of the knife contact surfaces or thread damage to the knife receptacles) due, for instance, to foreign objects such as stones or foreign metal entering the chopper unit, the damaged knife carriers must be replaced with intact knife carriers.

To do this, the entire chopper unit must be removed from the main machine. Next, the chopper drum must be removed from a drum housing enclosing the chopper drum. The chopper drum must be taken apart, the damaged knife carriers must be replaced and the chopper drum must be reassembled. After the knife carrier is replaced, the chopper drum must be rebalanced to ensure that imbalance does not occur. After the chopper drum is repaired, the components must be reinstalled in the reverse order. The amount of time required for this repair work is approximately 2.5 to 3 working days.

Due to the attachment of the outer knife carriers to the side of the drum body, a doubling of material occurs in the connection regions of the flange of the journals with the outer knife carriers. The extra material increases the overall weight of the chopper drum and making maintenance and repair work more difficult.

The lateral attachment of the outer knife carriers also reduces the width and the axial length of the drum body. As a result, crop particles can more easily enter the space between the chopper drum and the drum housing during the chopping process. This results in a greater circulation of crop that is not immediately conveyed further. The increased circulation of crop results in greater wear on the components located in the flow of the crop stream, such as the drum housing, the drum disk, etc.

The material blanks for the knife carriers are produced from larger base plates by means of flame or plasma cutting. In so doing, the degree of utilization of the plates is low due to the contour of the knife carriers having the shape of a circular-ring disk or a circular disk. As a result, the material blanks for the knife carriers are relatively material-intensive and, therefore, expensive to produce.

### SUMMARY OF THE INVENTION

The present invention overcomes the shortcomings of known arts, such as those mentioned above.

To that end, the present invention reduces the amount of effort required for the production, maintenance, and repair of a chopper drum of a forage harvester.

The invention provides a knife carrier for a chopper drum of a forage harvester.

In an embodiment, the invention provides a knife carrier for a chopper drum of a forage harvester. The knife carrier comprises a plurality of knife carrier segments each designed as a circular-ring disk section of a circular-ring disk, which can be accommodated on an outer diameter of a circular-cylindrical drum body of the chopper drum. Also, each of the knife carrier segments has an outer circumferential surface having a predetermined number of knife receptacles. Each of the knife carrier segments has a circumferential length such that all of the knife carrier segments form the circular-ring disk when placed next to one another along the circumferential length thereof. Each knife carrier segment has fixing means for the defined positioning of the knife carrier segment with respect to the drum body and for the detachable attachment of the knife carrier segment on the outer diameter of the drum body.

The knife carrier makes it (much) easier to repair a chopper drum equipped therewith, in the event the drum becomes damaged, for example. Since the knife carrier is subdivided into the individual knife carrier segments, the knife carrier segments can be removed/installed while remaining in the forage harvester or the drum housing. Hence, in the event a repair is required, there is no need to remove/install the entire chopper unit, to remove/install the chopper drum from or into the drum housing or to balance the chopper drum.

In the event a repair is required, depending on the particular damage, it may only be necessary to replace the damaged knife carrier segments of one or more partial circles. If a feeder housing of the forage harvester can be opened or swiveled away laterally to provide access to the chopper drum (which is preferable), when it becomes necessary to replace the knife carrier segments, one needs only to open the feeder housing in order to obtain the necessary access to the fixing means (e.g. fastening screws, dowel pins and groove/spring connections).

The improved ease-of-repair reduces the amount of work required, thereby greatly reducing the amount of time required to perform repair work and greatly reducing the repair costs. The amount of time required to repair the knife carrier according to the invention is reduced from approximately 2.5 to 3 working days to approximately 0.5 to 1 working day. This is of great benefit to the customer (shorter downtimes and, therefore, increased machine run times and increased efficiency), in particular in the peak season of use of the chopper, such as the corn harvest.

Due to the segmentation of the knife carrier, the material blanks have the contour of a circular-ring section. This results in a much higher degree of utilization, when flame or plasma cutting is used for production, than is the case with a one-piece knife carrier having a closed circular shape, resulting in lower material blank costs and production costs.

By designing the crude contour of the knife carrier segments as a circular-ring section, it also is possible to design the material blank as a cast or forged piece. Costs are further reduced as a result, due to the higher degree of material utilization. In addition, it is possible to improve the mechanical material properties of the knife carrier segments, e.g., by heat treatment such as annealing the forging blank.

The segmented knife carrier is markedly more lightweight than the above-described conventional, outwardly located knife carriers in the form of complete circular disks. The weight of the knife carrier according to the invention is therefore reduced considerably. The weight reduction simplifies the handling of the knife carriers, saving material and lowering operating costs.

As a result, the knife carrier according to the invention considerably reduces the amount of effort required for the production, maintenance and repair of a chopper drum of a forage harvester.

According to an embodiment, the fixing means each comprise a first engagement means. The first engagement means is matched in a form-fit manner to second engagement means provided on the outer diameter of the drum body of the chopper drum. Such arrangement results in a defined and predetermined radial positioning of the particular knife carrier segment with respect to the outer diameter of the drum body.

In this manner, knife carrier segments are mounted on the drum body such that any imbalance that results upon rotation of the drum body equipped with the knife carrier is minimal and the drum body or the fully installed chopper drum is substantially balanced.

According to an embodiment of the knife carrier, each knife carrier segment has two opposing end surfaces, which limit the circumferential length of the knife carrier segment. The end surfaces of the knife carrier segments are designed such that the knife carrier segments can be placed next to one another along the circumferential length thereof to form the circular-ring disk via end surfaces of circumferentially adjacent knife carrier segments, which adjoin one another in a flush manner free of undercuts.

Each knife carrier segment is therefore removable individually from the drum body and, e.g. replaced with a new knife carrier segment, without the need to remove the knife carrier segments that are circumferentially directly adjacent to this knife carrier segment. This further reduces the amount of effort required for repairs and maintenance.

In another embodiment of the knife carrier, the knife carrier segments are identical to one another and deviate from one another only slightly in terms of weight, i.e. by only a few grams. This advantageously supports the minimization of the repair effort since the thusly identically designed knife carrier segments can be replaced individually without generating an imbalance, which would have to be taken into consideration.

If a single knife carrier segment becomes damaged, however, it is preferable to simultaneously replace all the knife carrier segments that belong together and form a circular ring.

The invention also provides a chopper drum for a forage harvester comprising: a circular-cylindrical drum body having a predetermined outer diameter, and a knife carrier having a plurality of knife carrier segments, each in the form of a circular-ring disk section having a predetermined circumferential length. The knife carrier segments are preferably placed next to one another along the circumferential length thereof, thereby jointly forming a circular-ring disk about the outer diameter of the drum body. The knife carrier segments each have an outer-peripheral surface having a predetermined number of knife receptacles. First fixing means are provided on the particular knife carrier segments and second fixing means provided on the outer diameter of the drum body, which interact with one another, thereby ensuring that the knife carrier segments are each positioned in a defined manner relative to the drum body and are detachably attached to the outer diameter or the drum jacket thereof.

The chopper drum according to the invention has the same advantages as those described with respect to the knife carrier according to the invention, and so these advantages will be mentioned once more only briefly in the following.

Due to the subdivision of the knife carrier into the individual knife carrier segments, the chopper drum is much easier to repair. In the event a repair is required, depending on the particular damage, it may only be necessary to replace the damaged knife carrier segments of one or more partial circles.

The improved ease-of-repair reduces the amount of work required, thereby greatly reducing the amount of time required to perform repair work and greatly reducing the repair costs.

Due to the segmentation of the knife carrier, the material blanks have the contour of a circular-ring section. This results in a much higher degree of utilization, when flame or plasma cutting is used for production, than is the case with a one-piece knife carrier having a closed circular shape. This also results in lower material blank costs and production costs. The material blank can also be embodied as a cast or forged piece.

The segmented knife carrier is markedly more lightweight than the above-described conventional, outwardly located knife carriers in the form of complete circular disks. Therefore, the chopper drum according to the invention is considerably more lightweight, thereby simplifying the handling thereof and lowering the production and operating costs.

As a result, the amount of effort required for the production, repair, and maintenance of the chopper drum according to the invention is considerably reduced. According to an embodiment of the chopper drum, the first fixing means comprise first engagement means, and the second fixing means comprise second engagement means. The first and second engagement means are matched to one another in a form-fit manner such that defined radial positioning of each knife carrier segment with respect to the outer diameter of the drum body is achieved.

In this manner, knife carrier segments are mounted on the drum body such that any imbalance that results upon rotation of the chopper drum is minimal and the chopper drum is substantially balanced.

In an embodiment of the chopper drum, the drum body comprises a drum jacket, which defines the outer diameter thereof and has two axial ends pointing in opposite directions, wherein the second fixing means has a circular-ring disk-shaped fixing element, which is fixedly disposed on the outer diameter of the drum body. It follows that a first lateral boundary surface of the fixing element is located adjacent to an axial end of the drum body and faces the same direction thereof and, in particular, terminates this axial end in a substantially flush manner with this axial end.

In the chopper drum, an outer knife carrier can be mounted on the drum body and does not need to be placed on the side of the drum body. By preventing the doubling of material, as is described with respect to the conventional chopper drum, weight is saved and an axial extension or widening of the drum body is enhanced. This contributes to reduced wear due to a reduction in the amount of circulating crop.

In another embodiment of the chopper drum, the fixing element comprises the second engagement means on a second lateral boundary surface, which faces away from the first lateral boundary surface. The second engagement means are formed in the shape of a circular ring concentrically to the outer diameter of the drum body. The first engagement means on each knife carrier segment is formed in the shape of a circular-ring section on one of two lateral boundary surfaces thereof, corresponding to the circular-ring shape of the second engagement means.

The chopper drum advantageously supports installation of the knife carrier segments on the drum body that is simple and has minimal imbalance.

In another embodiment of the chopper drum, each knife carrier segment comprises two opposing end surfaces, which limit the circumferential length of the knife carrier segment. The end surfaces of the knife carrier segments are designed such that the knife carrier segments can be placed next to one another along the circumferential length thereof to form the circular-ring disk via end surfaces of circumferentially adjacent knife carrier segments, which adjoin one another in a flush manner free of undercuts.

In this manner, each knife carrier segment can be removed individually from the drum body and, e.g., replaced with a new knife carrier segment, without the need to remove the knife carrier segments that are circumferentially directly adjacent to this knife carrier segment. This further reduces the amount of effort required for repairs and maintenance.

In another embodiment of the chopper drum, the knife carrier segments are identical to one another and deviate from one another only slightly in terms of weight, i.e. by only a few grams. This advantageously supports the minimization of the repair effort since the thusly identically designed knife carrier segments can be replaced individually without generating an imbalance, which would have to be taken into consideration.

In another embodiment, this chopper drum comprises four knife carriers, wherein a first pair of these knife carriers is disposed on the drum jacket approximately in the axial center thereof, at a predetermined distance from one another. The knife carriers are each positioned and detachably attached there in a defined manner. Each knife carrier of a second pair of these knife carriers is disposed at one of the axial ends of the drum body and is positioned and detachably attached there in a defined manner.

For each of the knife carriers, to permit the defined positioning and detachable attachment thereof, a circular-ring disk-shaped fixing element equipped with above-described fixing means is fixedly disposed at a corresponding position on the outer diameter or the drum jacket of the drum body. The second engagement means of the fixing element disposed at the axial ends of the drum body each point toward the center of the drum body and the second engagement means of the fixing elements disposed in the center of the drum body each point toward the closer end of the drum body.

The arrangement of a plurality of knife carrier segments to form a knife carrier forms a complete partial circle of knife receptacles (having e.g. knife contact surfaces and threaded bores). The segmentation can be changed according to the different subdivisions and numbers of knives.

A subdivision into 10 can be achieved, e.g., by means of 2 identical knife carrier segments (half of a segment in each case), each of which has five knife receptacles. A subdivision into 12 can be achieved, e.g., by means of 3 identical knife carrier segments (a third of a segment in each case), each of which has four knife receptacles. A subdivision into 16 can be achieved, e.g., by means of 4 identical knife carrier segments (a fourth of a segment in each case), each of which has four knife receptacles.

The imbalance is held within a tolerable range by means of the exact radial positioning of the knife carrier segments of each knife carrier and, the therefore radially identical position of the knife carrier segments and by adhering to the weight tolerance of the knife carrier segments (in particular the limitation of the permissible weight deviation to a few grams). By balancing the drum body exactly, the permissible imbalance tolerances are fallen below to such an extent that a balancing procedure need not be carried out when the knife carrier segments are installed. In the event a repair is required, the replacement of a single segment or an entire set of segments does not increase the resultant imbalance by a decisive extent.

### BRIEF DESCRIPTION OF THE DRAWINGS

Further features and advantages of the invention will become apparent from the description of embodiments that follows, with reference to the attached figures, wherein:

FIG. 1 presents a perspective exploded view of a conventional chopper drum, wherein the cutting blades have been omitted for clarity;

FIG. 2 presents a perspective exploded view of a chopper drum according to the invention, wherein the cutting blades have been omitted for clarity;

FIG. 3 presents a radial sectional view of a part of the chopper drum depicted in FIG. 2; and

FIG. 4 presents a perspective view of a part of a forage harvester equipped with the chopper drum depicted in FIG. 2, wherein the cutting blades are mounted on the chopper drum.

### DETAILED DESCRIPTION OF THE PREFERRED EMBODIMENTS

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

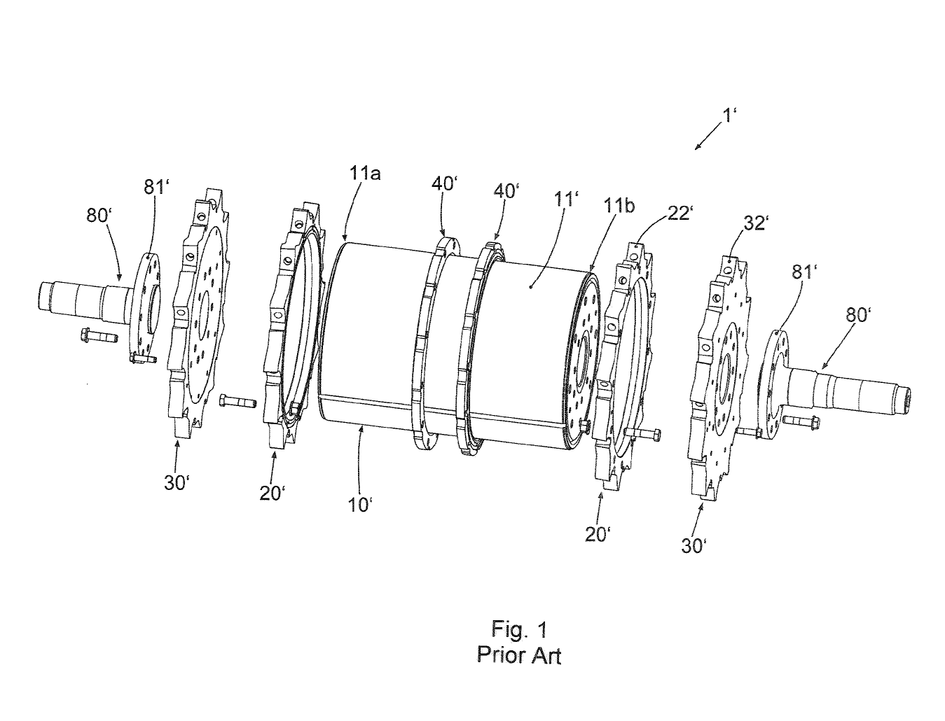

FIG. 1 presents a perspective exploded view of a conventional chopper drum 1′ for a forage harvester. The chopper drum 1′ comprises a circular-cylindrical drum body 10′ having a predetermined outer diameter and a plurality of knife carriers 20′, 30′, each of which has a plurality of knife receptacles 22′, 32′. In an assembled state (not shown in FIG. 1), each of these knife receptacles is positioned in a defined manner relative to the drum body 10′ and is detachably attached on the outer diameter thereof.

A drum jacket 11′ defining the outer diameter of the drum body 10′ has two axial ends 11a′, 11b′ pointing in opposite directions. A first pair of knife carriers 20′, 20′ (which are each designed as a circular-ring disk), are positioned on the drum jacket 11′ approximately in the axial center thereof, at a predetermined axial distance from one another, and are each detachably attached there by means of threaded connections (not shown). For the detachable attachment of each of the knife carriers 20′, 20′ of the first pair, a fixing element 40′ shaped as a circular-ring disk is fixedly disposed at a corresponding position on the outer diameter or on the drum jacket 11′ of the drum body 10′.

A second pair of knife carriers 30′, 30′ (which are each designed as circular disks), are mounted on the sides at the axial ends 11a′, 11b′ of the drum jacket 11′ and are each detachably attached there by means of threaded connections (not shown). A journal 80′ is detachably attached by means of threaded connections (not shown) to each of the two outer, circular-disk shaped knife carriers 30′, 30′ via a flange 81′ provided on each of the journals. This ensures that a rotatable support and a rotary drive of the chopper drum 1′ can be obtained by means of the journals 80′, 80′.

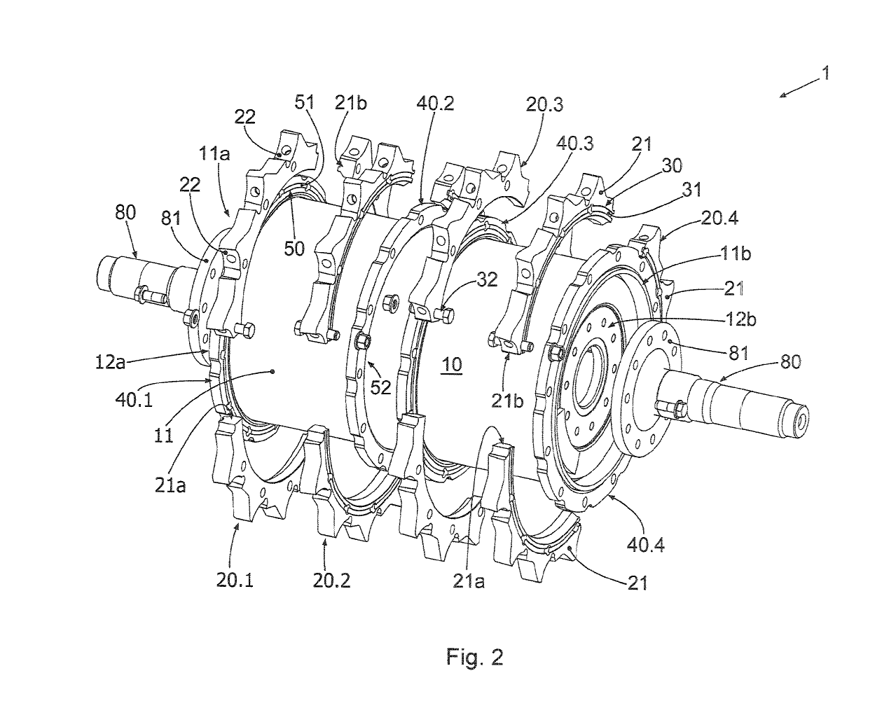

A chopper drum 1 for a forage harvester 100 according to an embodiment of the invention is described in the following by reference to FIGS. 2 to 4.

The chopper drum 1 comprises a circular-cylindrical drum body 10 having a predetermined outer diameter, four knife carriers 20.1, 20.2, 20.3, 20.4 (labeled in general with reference sign 20), four mutually identical circular-ring disk-shaped fixing elements 40.1, 40.2, 40.3, 40.4 (labeled in general with reference sign 40) for the knife carriers 20 and two journals 80 for a rotatable support and a rotary drive of the chopper drum 1.

The outer diameter of the drum body 10 is defined by a drum jacket 11, which has two axial ends 11a, 11b pointing in opposite directions.

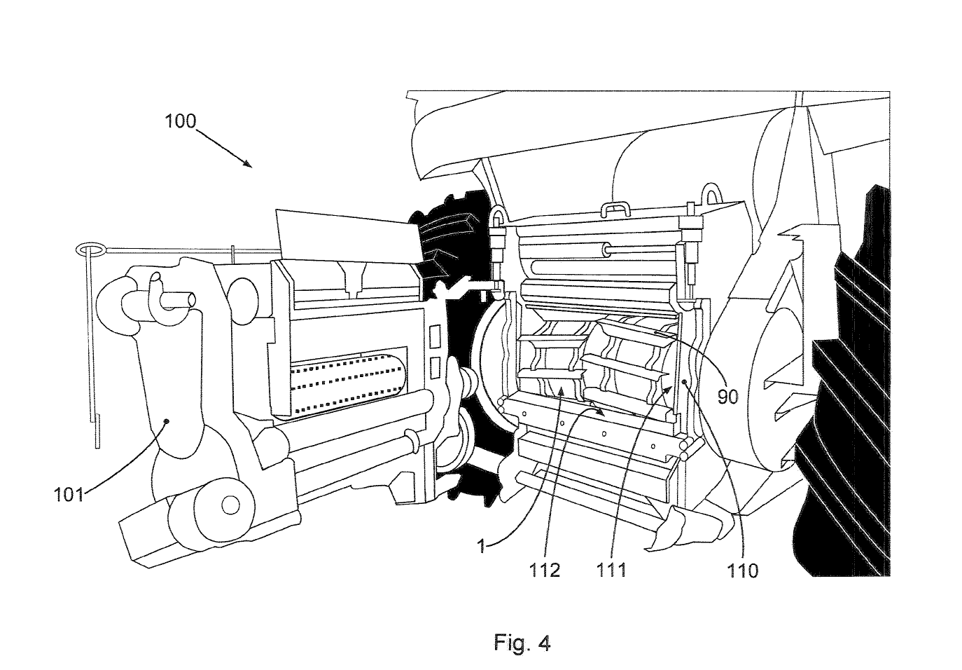

Each of the four knife carriers 20 comprises a plurality of knife carrier segments (e.g. three knife carrier segments 21 in this case), each of which is designed as a circular-ring disk section or a circular-ring disk sector of a circular-ring disk that can be accommodated on the outer diameter or the drum jacket 11 of the drum body 10. Each of the knife carrier segments has an outer-peripheral surface having a predetermined number of knife receptacles 22 (having receiving surfaces and threaded bores, which are not labeled separately) for receiving and fastening cutting blades 90 (see FIG. 4).

The knife carrier segments 21 of each knife carrier 20 are mutually identical and deviate from one another only slightly in terms of weight, i.e., by only a few grams (preferably by not more than ±30 grams). The circumferential length or curve length) of the knife carrier segments 21 is such that all the knife carrier segments 21 of a knife carrier 20 (three knife carrier segments 21 in the example shown) form the circular-ring disk enclosing the outer diameter or the drum jacket 11 of the drum body 10 when placed next to one another along the circumferential length thereof.

Each knife carrier segment 21 has two opposing end surfaces 21a, 21b. The two opposing end surfaces 21a, 21b limit the circumferential length thereof and are designed such that the knife carrier segments 21 can be placed next to one another along the circumferential length to form the circular-ring disk via end surfaces 21a, 21b of circumferentially adjacent knife carrier segments 21, which adjoin one another in a flush manner free of undercuts. That is, the end surfaces 21a, 21b are preferably flat and preferably each extend (in a virtual extension), to a center of the particular circular ring in a manner similar to planes of sections of corresponding circular sections or sectors of a circle.

In an embodiment, the knife carrier segments are disposed at a distance from one another and do not form a closed ring around the drum jacket.

Every knife carrier segment 21 also comprises a first fixing means 30 for the defined positioning of the knife carrier segment 21 with respect to the drum body 10 and for the detachable attachment of the knife carrier segment 21 on the outer diameter or the drum jacket 11 of the drum body 10.

The four fixing elements 40 form a second fixing means 50 in each case, which are used, in interaction with the first fixing means 30 of the knife carrier segments 21, for the defined positioning of the knife carrier segments 21 relative to the drum body 10. The second fixing means also are used for the detachable attachment of the knife carrier segments 21 on the outer diameter or the drum jacket 11 of the drum body 10. Each fixing element 40 is fixedly disposed on the outer diameter or the drum jacket 11 of the drum body, e.g., by welding and thereby preferably encloses same.

The first fixing means 30 comprise first engagement means 31 in the form of a fitting groove and first threaded connecting means 32 in the form of threaded holes and threaded screws (designed as dowel screws, for example). The second fixing means 50 comprise second engagement means 51 in the form of a parallel key and second threaded connecting means 52 in the form of threaded holes and threaded nuts. The threaded holes of the first threaded connecting means 32 and the threaded holes of the second threaded connecting means 52 are provided with the same hole spacing, to permit these to be aligned with one another and thereby permit the threaded screws to be extended therethrough.

The second engagement means 51 (parallel key) are formed on each fixing element 40, on one of two lateral boundary surfaces thereof, in the shape of a circular ring concentrically to the outer diameter of the drum body 10. The first engagement means 31 (fitting groove) are formed on each knife carrier segment 21, on one of two lateral boundary surfaces thereof, in the shape of a circular-ring section corresponding to the circular-ring shape of the second engagement means 51 (i.e. having the same radius of curvature or curved on the same circle).

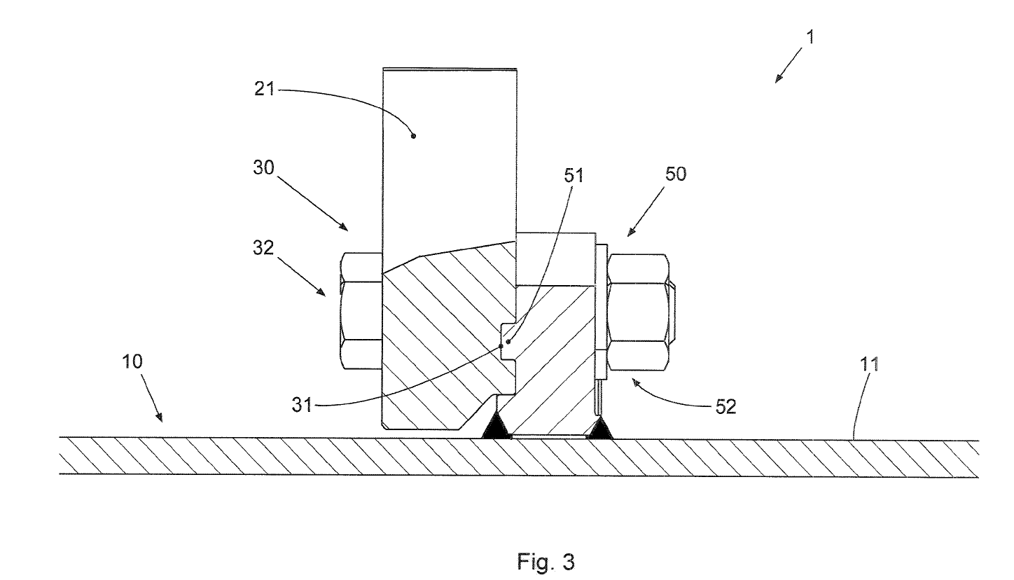

The first engagement means 31 (fitting groove) of the knife carrier segments 21 and the second engagement means 51 (parallel key) of the fixing elements 40 are matched in a form-fit manner to permit interaction (as shown in FIG. 3), thereby resulting in a defined radial positioning of the particular knife carrier segments 21 relative to the outer diameter of the drum body 10. The first and second threaded connecting means 32, 52 interact by means of the threaded screws extended through the threaded holes and screwing the threaded screws together with the threaded nuts, and are used for circumferential and axial positioning, and for the detachable attachment of the knife carrier segments 21 on the particular fixing element 40.

A first pair of fixing elements 40.2, 40.3 is disposed on the drum jacket 11 approximately in the axial center thereof, at a predetermined distance from one another. The second engagement means 51 (the parallel key) of these fixing elements 40.2 and 40.3 (which are disposed approximately in the axial center of the drum jacket 11), face the closer axial end 11a and 11b, respectively, of the drum jacket 11. It is also possible to dispose the fixing elements 40.2, 40.3 in the reverse orientation, whereupon the second engagement means 51 face the axial ends located further away.

A second pair of fixing elements 40.1, 40.4 is disposed on the drum jacket 11 such that each of these two fixing elements 40.1 and 40.4 is located at one axial end 11a and 11b, respectively, of the two axial ends 11a, 11b of the drum jacket 11. The second engagement means 51 (the parallel key) of the fixing elements 40.1, 40.4 disposed at the axial ends 11a, 11b of the drum jacket 11 each point toward the center of the drum jacket 11. In this configuration, the particular lateral boundary surface of these fixing elements 40.1 and 40.4 that is not equipped with the second engagement means 51 (the parallel key) is disposed adjacent to and, in particular, substantially flush with the axial end 11a and 11b, respectively, of the drum jacket 11 in a terminating manner and facing the same direction as these axial ends. Alternatively, the fixing elements 40.1 and 40.4 can be disposed in the reverse orientation, whereupon the second engagement means 51 face outwardly.

In a variation, the first engagement means of the knife carrier segments also can be designed alternatively as parallel keys that interact with corresponding second engagement means of the fixing elements designed as a fitting groove.

In the assembled state of the chopper drum 1, one of the journals 80 is fastened on each of two lateral boundary surfaces 12a, 12b of the drum body 10 via a flange 81 provided thereon in each case, by means of threaded screws (not shown). The arrangement makes it possible to obtain a rotatable support and a rotary drive of the chopper drum 1 via the journals 80, 80.

When the chopper drum 1 is assembled, i.e. the knife carrier segments 21 of each knife carrier 20 are placed next to one another along the circumferential length thereof and are each positioned and detachably attached on the particular assigned fixing element 40 in a defined manner with respect to the drum body 10. Accordingly, the knife carrier segments 21 of each knife carrier 20 jointly form a particular circular ring disk around the outer diameter of the drum body 10 and the cutting blades 90 can be mounted on the knife receptacles 22 of the knife carrier 20.

The cutting blades 90 (which are preferably designed as impeller blades) are preferably assembled as shown in FIG. 4 such that a first group of cutting blades 90 (the cutting blades 90 fastened on the chopper drum 1 on the left in FIG. 4) is fastened by means of threaded screws on the two knife carriers 20.1, 20.2 (shown on the left in FIG. 2) and thereby bridge these knife carriers. A second group of cutting blades 90 (the cutting blades 90 fastened on the chopper drum 1 on the right in FIG. 4) is fastened on the two knife carriers 20.3, 20.4 shown on the right in FIG. 2 by means of threaded screws and thereby bridge these knife carriers. The cutting blades of the two groups are preferably allowed to bridge or extend toward the center to such an extent that they each extend beyond the center and overlap via the cutting regions thereof.

As shown in FIG. 4, the forage harvester 100 comprises a feeder housing 101, which can be opened or swivelled away laterally as needed (e.g. in order to perform maintenance or if damage occurs) to provide access to the chopper drum 1, for example.

FIG. 4 also shows that the chopper drum 1 can be accessed, when the feeder housing is opened 101, via a substantially rectangular opening 111 of a drum housing 110 of the forage harvester 100, which accommodates the chopper drum 1. The crop to be chopped is fed to the chopper drum 1 via this opening 111. A stationary shear bar 112 is disposed at the lower edge of the opening 111, wherein the cutting blades 90 interact with this shear bar during operation in order to chop the crop.

If one or more knife carrier segments 21 of the chopper drum 1 have become damaged (e.g. the thread in the knife receptacles 22 has been destroyed and/or the receiving surfaces thereof have been damaged) due to the effect of a foreign object (for example), the cutting blades 90 belonging to the relevant knife carrier segments 21 can be removed via the opening 111. Then, the relevant knife carrier segments 21 can be removed individually and replaced with intact knife carrier segments 21. Finally, intact cutting blades 90 are installed on the replaced knife carrier segments 21, whereupon the repair has been completed.

Dowel pin connections and/or dowel screws are provided for the exact predetermined positioning of the knife carrier segments in the circumferential direction. Alternatively, the knife carrier segments are positioned in the circumferential direction with the aid of assembling jigs.

In addition to the aforementioned impeller blades, any other known shapes of blades can be disposed on the knife carrier segments, such as straight blades or hook-shaped blades, for example. It may be necessary to provide suitable adaptation means as adapters.

As an alternative to the use of adaptation means, however, the knife carrier segments can be replaced with knife carrier segments having correspondingly shaped receptacles.

In addition to the embodiment with three knife carrier segments, embodiments also are possible that comprise only two or even more than three knife carrier segments.

A chopper drum can be easily retrofitted in terms of the number of knives it comprises by replacing the knife carrier segments with knife carrier segments having a different number of knife receptacles.

Preferably, all the knife carrier segments of the different subdivision variants are manufactured such that they fit the fixing means mounted on the drum jacket.

### LIST OF REFERENCE SIGNS

1; 1′ chopper drum
10; 10′ drum body
11; 11′ drum jacket
11a; 11a′ axial end
11b; 11b′ axial end
12a, 12b lateral boundary surface
20; 20′ knife carrier
20.1 knife carrier
20.2 knife carrier
20.3 knife carrier
20.4 knife carrier
21 knife carrier segment
21a, 21b end surface
22; 22′ knife receptacle
30′ knife carrier
32′ knife receptacle
30 fixing means
31 engagement means
32 threaded connecting means
40; 40′ fixing elements
40.1 fixing element
40.2 fixing element
40.3 fixing element
40.4 fixing element
50 fixing means
51 engagement means
52 threaded connecting means
80; 80′ journal
81; 81′ flange
90 cutting blade
100 forage harvester
101 feeder housing
110 drum housing
111 opening
112 shear bar

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A knife carrier (20) for a chopper drum (1) of a forage harvester (100), comprising
a plurality of knife carrier segments (21) designed as a circular-ring disk sections for positioning on an outer diameter of a circular-cylindrical drum body (10) of the chopper drum (1),
wherein each of the knife carrier segments (21) comprises an outer-peripheral surface having a predetermined number of knife receptacles (22) and fixing means (30) for the defined positioning of the knife carrier segment (21) with respect to the drum body (10) and for the detachable attachment of the knife carrier segment (21) on the outer diameter of the drum body (10).

2. The knife carrier (20) according to claim 1, wherein the fixing means (30) each comprises a first engagement means (31) that is matched in a form-fit manner to second engagement means (51) provided on the outer diameter of the drum body (10) of the chopper drum (1), thereby resulting in a defined radial positioning of the particular knife carrier segment (21) with respect to the outer diameter of the drum body (10).

3. The knife carrier (20) according to claim 1, wherein each knife carrier segment (21) has two opposing end surfaces (21a, 21b) that limit the circumferential length of the knife carrier segment (21), wherein end surfaces (21a, 21b) of the knife carrier segments (21) are designed such that the knife carrier segments (21) are placeable next to one another along the circumferential length thereof to form the circular-ring disk via end surfaces (21a, 21b) of circumferentially adjacent knife carrier segments (21), which adjoin one another in a flush manner free of undercuts.

4. The knife carrier (20) according to claim 1, wherein the knife carrier segments (21) are mutually identical and deviate from one another in terms of weight by no more than ±30 grams.

5. A chopper drum (1) for a forage harvester (100), comprising:
a circular-cylindrical drum body (10) having a predetermined outer diameter, and
a knife carrier (20) having a plurality of knife carrier segments (21), each in the shape of a circular-ring disk section having a predetermined circumferential length and including an outer-peripheral surface having a predetermined number of knife receptacles (22),
wherein first fixing means (30) is provided on the particular knife carrier segments (21) and second fixing means (50) is provided on the outer diameter of the drum body (10), wherein the first fixing means (30) and the second fixing means (5) interact with one another, thereby ensuring that the knife carrier segments (21) are each positioned in a defined manner relative to the drum body (10) and are detachably attached to the outer diameter thereof.

6. The chopper drum (1) according to claim 5, wherein the first fixing means (30) comprises first engagement means (31), wherein the second fixing means (50) comprises second engagement means (51), and wherein the first and second engagement means (31, 51) are matched to one another in a form-fit manner to achieve a defined radial positioning of each knife carrier segment (21) with respect to the outer diameter of the drum body (10).

7. The chopper drum (1) according to claim 6, wherein the drum body (10) comprises a drum jacket (11) that defines an outer diameter thereof and has two axial ends (11a, 11b) pointing in opposite directions, and wherein the second fixing means (50) has a circular-ring disk-shaped fixing element (40.1, 40.2) that is fixedly disposed on the outer diameter of the drum body (10).

8. The chopper drum (1) according to claim 7, wherein the fixing element (40.1, 40.4) comprises the second engagement means (51) on a second lateral boundary surface facing away from the first lateral boundary surface, wherein the second engagement means (51) are formed in the shape of a circular ring concentrically to the outer diameter of the drum body (10), and wherein the first engagement means (31) are formed on each knife carrier segment (21), on one of two lateral boundary surfaces thereof, in the shape of a circular-ring section corresponding to the circular-ring shape of the second engagement means (51).

9. The chopper drum (1) according to claim 5, wherein each knife carrier segment (21) has two opposing end surfaces (21a, 21b) that limit the circumferential length of the knife carrier segment (21), and wherein the end surfaces (21a, 21b) of the knife carrier segments (21) are designed such that the knife carrier segments (21) can be placed next to one another along the circumferential length thereof to form the circular-ring disk via end surfaces (21a, 21b) of circumferentially adjacent knife carrier segments (21) that adjoin one another in a flush manner free of undercuts.

10. The chopper drum (1) according to claim 5, wherein the knife carrier segments (21) are mutually identical and deviate from one another in terms of weight by no more than ±30 grams.
